(19) United States
(12) Patent Application Publication
(10) Pub. No.: US 2007/0054516 A1
(43) Pub. Date: Mar. 8, 2007

(54) Device to combine a transformer and a power supply connector

(76) Inventor: Chang-Liang Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,360

(22) Filed: Aug. 16, 2005

(51) Int. Cl. H01R 12/00

(52) U.S. Cl. 439/79

(57) ABSTRACT

A device to combine a transformer and a power supply connector comprises a main body, a transformer connected to the main body, and a power supply connector secured on the main body. The main body comprises feet. The power supply connector comprises a pin hander, or the power supply connector is an electrical wire for connection with network or the circuit board of communication equipment. This design can be modularized for mass production in order to lower manufacture cost.

### BACKGROUND OF THE INVENTION

1. Field of the Invention

The present invention relates to a device to combine a transformer and a power supply connector, and more particularly to a device for connection with network or the circuit board of communication equipment so as be modularized for mass production.

2. Description of the Related Prior Art

A network card or circuit board currently used on the market is to connect a transformer and a power supply connector directly to the circuit board. The problem is that the circuitry of the circuit board has to be well defined in advance in order to match the transformer and the power supply connector. Thus the design is complicated and has a higher manufacture cost, moreover, it may produce noises in use.

### SUMMARY OF THE INVENTION

It is the primary object of the present invention to provide a device to combine a transformer and a power supply connector, which is modularized and is easy to control the cost and quality.

It is another object of the present invention to provide a device to combine a transformer and a power supply connector, which provides a solution to eliminate noises.

It is a further object of the present invention to provide a device to combine a transformer and a power supply connector, which is easy to operate and maintain.

It is still a further object of the present invention to provide a device to combine a transformer and a power supply connector, which is more competitive on the market both in price and in quality.

### BRIEF DESCRIPTION OF THE DRAWINGS

FIG. 1 is a perspective view of the present invention;

FIG. 2 is a perspective view of the present invention covered with a case;

FIG. 3 is a second embodiment of the present invention; and

FIG. 4 is a third embodiment of the present invention.

### DETAILED DESCRIPTION OF THE PREFERRED EMBODIMENTS

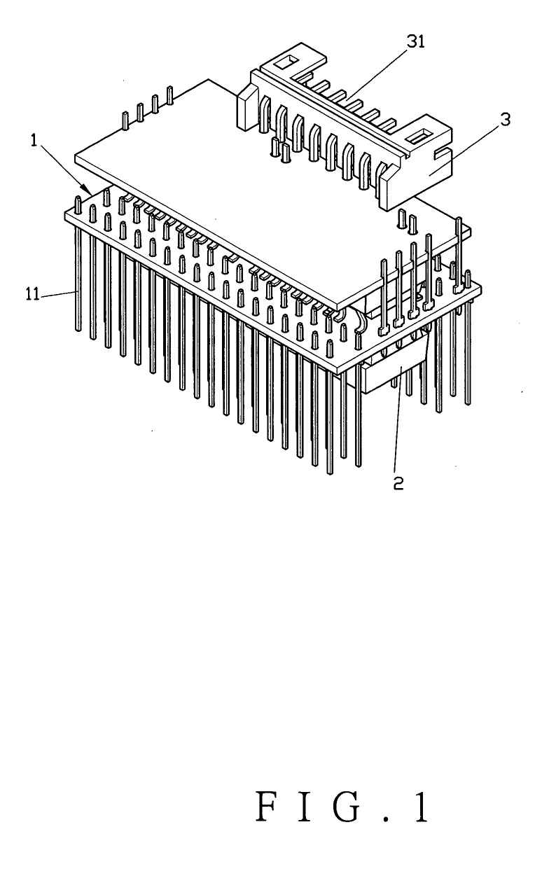

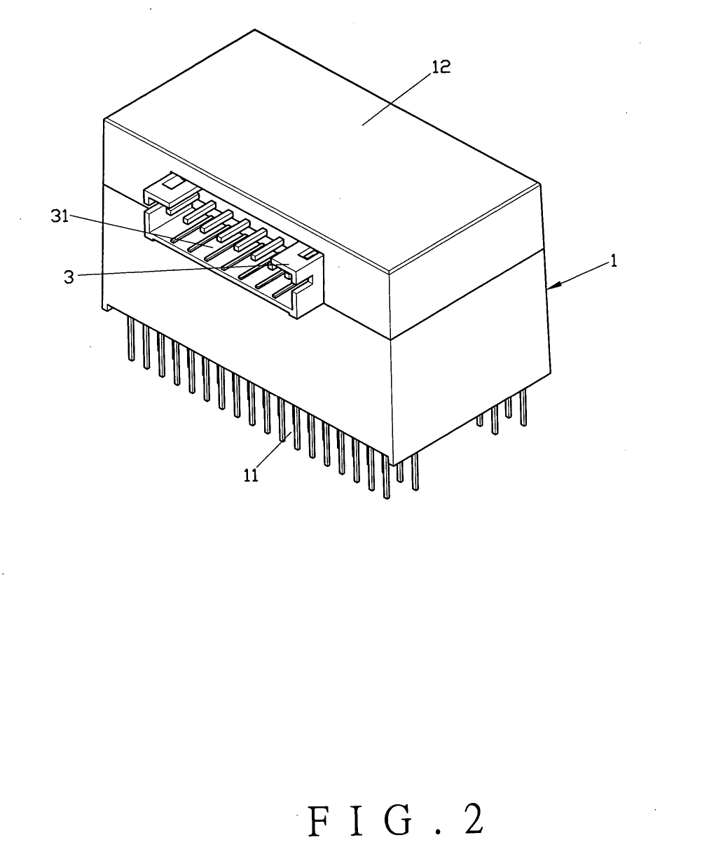

As shown in FIGS. 1 and 2, the present invention comprises a main body 1, a transformer 2 and a power supply connector 3. The main body 1 has feet 11 to be inserted into the apertures of a circuit board (not shown in the drawings). Both the transformer 2 and the power supply connector 3 are secured to the main body 1. In this embodiment, the power supply connector 3 comprises a pin hander 31 for connection of a power supply plug. As shown in FIG. 2, the present invention further comprises a case 12 to cover the main body 1. The direction of the power supply connector 3 has turned 180 degrees with respect to the power supply connector 3 in FIG. 1, which is so designed for different products.

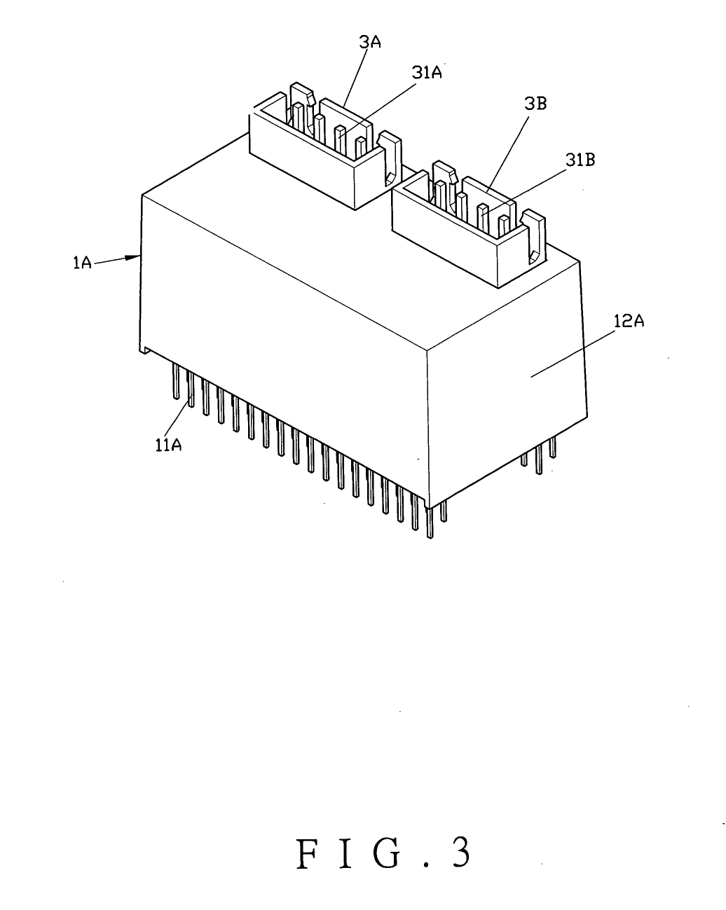

FIG. 3 shows a second embodiment of the present invention, which comprises a main body 1A having feet 11A, a cover 12A, and at least a pair of power supply connectors 3A and 3B. The power supply connectors 3A and 3B comprise pin handers 31A and 31B, respectively, for various products.

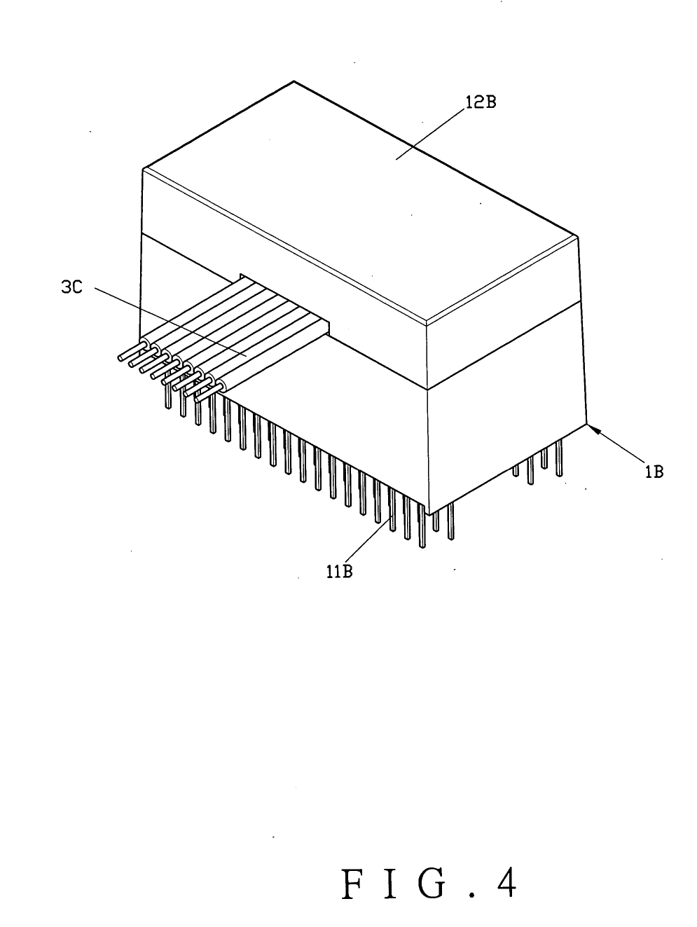

FIG. 4 shows a third embodiment of the present invention, which comprises a main body 1B having feet 11B, a cover 12B, and a power supply connector 3C. The power supply connector 3C of this design is an electrical wire.

I claim:

1. A device to combine a transformer and a power supply connector comprising a main body, a transformer and a power supply connector, said main body comprising feet, said transformer and said power supply connector being secured to said main body.

2. The device to combine a transformer and a power supply connector, as recited in claim 1, wherein said power supply connector comprises a pin hander.

3. The device to combine a transformer and a power supply connector, as recited in claim 1, wherein said power supply connector is an electrical wire.
